(19) United States
(12) Patent Application Publication
(10) Pub. No.: US 2010/0091195 A1
(43) Pub. Date: Apr. 15, 2010

(54) De-ringing Device and Method

(75) Inventors: Wei-Kuo Lee, Hsinchu Hsien (TW); Shih-Chang Lai, HsinChu (TW); Po-Ming Chen, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/575,549

(22) Filed: Oct. 8, 2009

(30) Foreign Application Priority Data
Oct. 9, 2008 (TW) 097138824

(51) Int. Cl. H04N 5/21; G06K 9/40

(52) U.S. Cl. 348/607; 348/625; 382/269; 348/E05.077

(57) ABSTRACT

A de-ringing device and a method thereof are provided. The de-ringing device, operative with a lookup table for storing a plurality of intensity coefficients, comprises a buffer and a de-ringing intensity determining unit. The buffer stores an input pixel sequence. The lookup table stores a plurality of intensity coefficients. The de-ringing intensity determining unit, coupled to the buffer and the lookup table, detects a plurality of pixel complexity of a first pixel group and a second pixel group associated with a target pixel in the pixel sequence, and looks up the lookup table according to the pixel complexities of the first pixel group and the second pixel group to output a de-ring intensity coefficient for the target pixel.

### CROSS REFERENCE TO RELATED PATENT APPLICATION

This patent application is based on a Taiwan, R.O.C. patent application No. 97138824 filed on Oct. 9, 2008.

### FIELD OF THE INVENTION

The present invention relates to image processing, and more particularly, to a de-ringing device and a method thereof.

### BACKGROUND OF THE INVENTION

Referring to FIG. 1A, in a conventional display device, in order to sharpen an image, a sharpness enhancement circuit 11 processes an input video signal received by a display device such that an output video signal with enhanced sharpness is outputted. The sharpness enhancement circuit 11 utilizes a filter to magnify differences between adjacent pixels to enhance the sharpness, thus ringing effect of the image is easily resulted. FIG. 1B shows an input video waveform composed of a plurality of pixel values. FIG. 1C shows an output video waveform by processing the input video signal using the sharpness enhancement circuit 11. A trough 12 and a peak 13 occur when the waveform rises from low to high, i.e. so-called ringing. The ringing shall cause an abrupt edge in the image, and the abrupt edge, such as the peak 13 or the trough 12, compared to adjacent pixels, appears too bright or too dark. Consequently, an overall image display effect is greatly deteriorated.

### SUMMARY OF THE INVENTION

In view of the foregoing issues, one object of the present invention is to provide a de-ringing device capable of determining a proper de-ringing intensity to improve an overall display effect of an image, and a method thereof.

The present invention discloses a de-ringing device, operative with a lookup table. The de-ringing device comprises a buffer, and a de-ringing intensity determining unit. The buffer temporarily stores an input pixel sequence. The lookup table stores a plurality of intensity coefficients. The de-ringing intensity determining unit, coupled to the buffer and the lookup table, detects a pixel complexity of a first pixel group and a second pixel group associated with a target pixel in the input pixel sequence, and looks up the lookup table according to the pixel complexities of the first pixel group and the second pixel group, so as to determine a de-ringing intensity coefficient corresponding to the target pixel.

The present invention further discloses a de-ringing method, comprising steps of providing a lookup table for storing a plurality of intensity coefficients, receiving an input pixel sequence, detecting a plurality of pixel complexities of a first pixel group and a second pixel group associated with a target pixel in the input pixel sequence, and looking up the lookup table according to the pixel complexities of the first pixel group and the second pixel group to determine a de-ringing intensity coefficient corresponding to the target pixel. A pixel length of the first pixel group and a pixel length of the second pixel group are determined according to an image resolution of the input pixel sequence.

### BRIEF DESCRIPTION OF THE DRAWINGS

FIG. 1A is a schematic diagram of a conventional display device enhancing sharpness of an image.

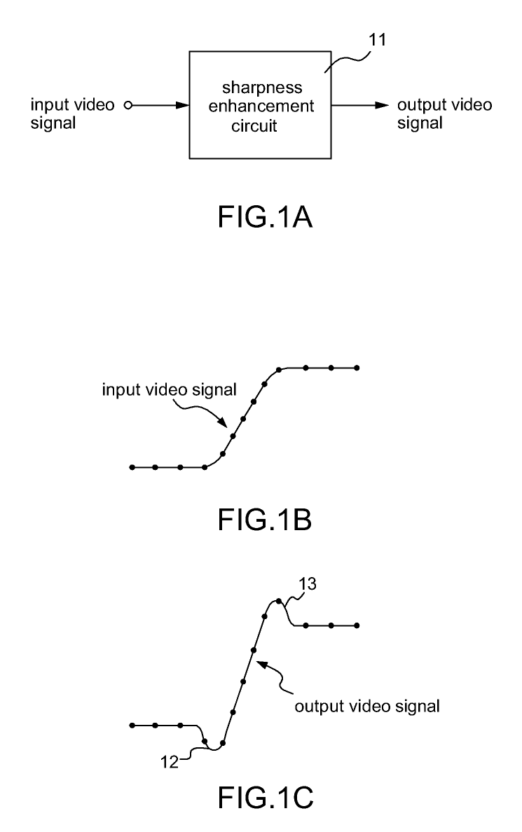

FIGS. 1B and 1C respectively show waveforms before and after sharpening an input video signal according to the prior art.

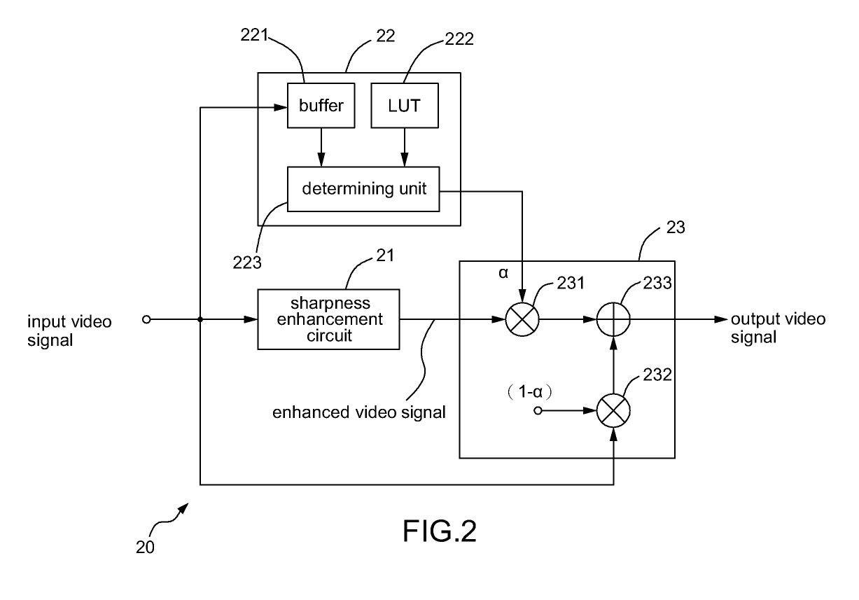

FIG. 2 is a block diagram of a de-ringing device in accordance with an embodiment of the present invention.

FIG. 3 is a relationship diagram between complexity and an image area.

FIG. 4A, FIG. 4B and FIG. 4C respectively show examples of a first pixel group and a second pixel group having different numbers of overlapped pixels.

FIG. 5 is a block diagram of a de-ringing device in accordance with another embodiment of the present invention.

FIG. 6 is a flow chart of a de-ringing method in accordance with a preferred embodiment of the present invention.

### DETAILED DESCRIPTION OF THE PREFERRED EMBODIMENT

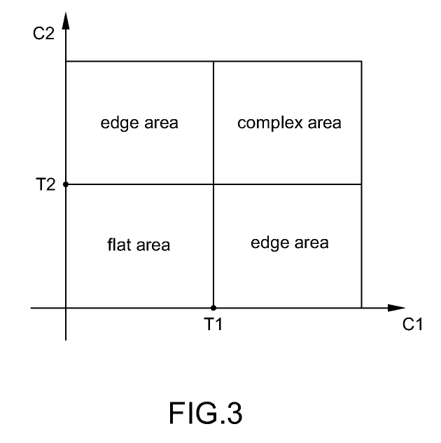

FIG. 2 is a block diagram of a de-ringing device 20 in accordance with an embodiment of the present invention. The de-ringing device 20 comprises a sharpness enhancement circuit 21, a de-ringing intensity controller 22 and a blending unit 23. The sharpness enhancement circuit 21 receives an input video signal represented by an input pixel sequence comprising a plurality of pixels. The input pixel sequence may comprise a horizontal line, a vertical line or a diagonal line of an image. For example, the sharpness enhancement circuit 21 can be a filter, which enlarges differences between the pixels of the input pixel sequence and adjacent pixels to enhance image sharpness and output an enhanced video signal, or called an enhanced pixel sequence.

The de-ringing intensity controller 22 comprises a buffer 221, a lookup table 222 and a de-ringing intensity determining unit 223. The buffer 221 receives the input video signal, and temporarily stores a part of the input pixel sequence, such as a display window. The lookup table 222 stores a plurality of intensity coefficients. The de-ringing intensity determining unit 223 defines two input pixel subsets associated with a target pixel of the input pixel sequence. The two input pixel subsets are respectively called a first pixel group and a second pixel group, of which a pixel complexity C1 and a pixel complexity C2 are detected respectively. A de-ringing intensity coefficient corresponding to the target pixel is then determined according to the pixel complexities C1 and C2. The de-ringing intensity determining unit 223 determines a de-ringing intensity coefficient corresponding to each pixel of the input pixel sequence. For example, each pixel of the input pixel sequence is regarded as the target pixel. The de-ringing intensity coefficients are generated to the blending unit 23 to perform blending to be described in detail. In this embodiment, the first pixel group comprises M pixels before the target pixel, and the second pixel group comprises N pixels after the target pixel, where M and N are positive integers. C1 and C2 respectively represent the pixel complexities of the pixels in the input pixel sequence before and after the target pixel. Preferably, values of M and N are programmed in a register (not shown) of the de-ringing intensity controller 22. Alternatively, the values of M and N are automatically adjusted according to an image resolution of the image. For instance, when the image resolution is high, differences between the neighboring pixels are increased and hence smaller values of M and N are enough to reflect the pixel complexities of the pixels in the input pixel sequence before and after the target pixel. When the image resolution is low, M and N are preferably greater.

For example, the pixel complexity C1 of the first pixel group is determined according to a difference between a greatest pixel value and a smallest pixel value in the first pixel group. The pixel complexity C2 of the second pixel group is determined according to a difference between a greatest pixel value and a smallest pixel value in the second pixel group. Alternatively, the pixel complexity C1 is determined according to a standard deviation of the pixel value in the first pixel group, and the pixel complexity C2 is determined according to a standard deviation of the pixel value in the second pixel group. Alternatively, the pixel complexities C1 and C2 are determined according to a sum of absolute differences between adjacent pixel values. According to the foregoing disclosure, a person having ordinary skills in the art can make various modifications with respect to detecting the pixel complexities of the first pixel group and the second pixel group. The spirit and scope of the appended claims shall encompass all various modifications and similar arrangements.

The blending unit 23, coupled to the sharpness enhancement circuit 21 and the de-ringing intensity controller 22, performs alpha blending on the input video signal and the enhanced video signal generated by the sharpness enhancement circuit 21, according to a de-ringing intensity coefficient called a generated by the de-ringing intensity controller 22, to generate an output video signal. Therefore, the blending unit 23 performs alpha blending on the target pixel of the input pixel sequence and an enhanced target pixel of an enhanced pixel sequence, to generate the output video signal with removed ringing effect. For example, the blending unit 23 comprises a multiplier 231, a multiplier 232 and an adder 233. The multiplier 231 multiplies the enhanced video signal generated by the sharpness enhancement circuit 21 by the de-ringing intensity coefficient α generated by the de-ringing intensity determining unit 22. The multiplier 232 multiplies the target pixel by a difference between 1 and the de-ringing intensity coefficient α, i.e., 1−α. The adder 233 sums up outputs of the multiplier 231 and 232 to complete alpha blending. Accordingly, when the de-ringing intensity coefficient becomes greater, the proportion of the enhanced video signal in alpha blending is greater. That is, when the proportion of the input video signal becomes smaller, it means that the tendency to enhance the sharpness stands more dominant. Accordingly, the de-ringing effect becomes weaker. Conversely, when the de-ringing intensity coefficient becomes smaller, the proportion of the enhanced video signal in the alpha blending calculation is smaller. That is, when the proportion of the input video signal becomes greater, it means that the tendency to remain at an original appearance of the input video signal prevails. Accordingly, the de-ringing effect becomes stronger. It should be noted that, the type of blending performed by the blending unit 23 is not limited to alpha blending. Provided that the proportions of the input video signal and the enhanced video signal in the output video signal generated by the calculation performed by the blending unit 23 vary along with changes of the de-ringing intensity coefficient, various blending algorithms may be applied and are included within the scope of invention.

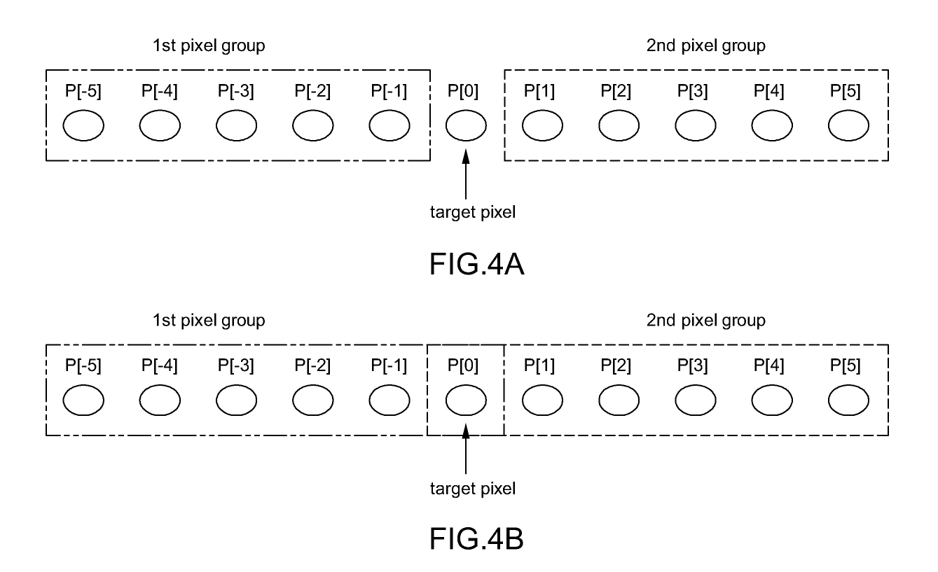

In this embodiment, the de-ringing intensity determining unit 223 determines the de-ringing intensity coefficient, according to a comparison result of the pixel complexity C1 in the first pixel group and a first threshold T1 and a comparison result of the pixel complexity C2 in the second pixel group and a second threshold T2. Refer to FIG. 3 showing types of image areas where the target pixel is located, such as a flat area, a complex area, an edge area and so on. The types are determined according to the comparison result of C1 and T1 and the comparison result of C2 and T2. For example, when C1 is greater than T1 and C2 is smaller than T2, it means that the pixel complexity of the input pixel sequence before the target pixel is high and the pixel complexity of the input pixel sequence after the target pixel is low. That is, the pixels before the target pixel are in the complex area, and the pixels after the target pixel are in the flat area, meaning that the target pixel possibly positions at an edge of the image. Similarly, when C1 is smaller than T1 and C2 is greater than T2, it means that the pixel complexity of the input pixel sequence before the target pixel is low, and the pixel complexity of the input pixel sequence after the target pixel is high. That is, the pixels before the target pixel are in the flat area, and the pixels after the target pixel are in the complex area, meaning that the target pixel possibly positions at an edge of the image. With respect to a situation that the target pixel positions at an edge of the image, the de-ringing intensity determining unit 223 generates a de-ringing intensity coefficient corresponding to a high de-ringing intensity. Consequently, when the blending unit 23 performs alpha blending, the original appearance of the input video signal is maintained to remove ringing effect and avoid abrupt edges in the image.

On the contrary, when C1 is smaller than T1 and C2 is smaller than T2, the pixel complexities of the input pixel sequence before and after the target pixel are both low. That is, the pixels before and after the target pixel are both in the flat area, meaning that the target pixel is in the flat area. Since the input pixel sequence positions in the flat area, the ringing effect caused by the sharpness enhancement circuit 21 is not obvious such that de-ringing is not needed much. Therefore, the de-ringing intensity determining unit 223 generates a de-ringing intensity coefficient corresponding to a low de-ringing intensity, so as to increase the proportion of the enhanced video signal when the blending unit 23 performs alpha blending. Furthermore, when C1 is greater than T1 and C2 is greater than T2, the pixel complexities of the input pixel sequence before and after the target pixel are both high. The pixels before and after the target pixel are both in the flat area, meaning that the target pixel positions in the complex area. Since the input pixel sequence is in the complex area, the ringing effect caused by the sharpness enhancement circuit 21 may further enhance the sharpness of the image without resulting in an undesirable effect, namely, the abrupt edges. Therefore, the de-ringing intensity determining unit 223 generates a de-ringing intensity coefficient corresponding to a low de-ringing intensity, so as to increase the proportion of the enhanced video signal when the blending unit 23 performs alpha blending.

Referring to FIG. 3, the first threshold T1 and the second threshold T2 are adjusted by users. In this embodiment, the lookup table 222 in FIG. 3 can be provided outside the de-ringing intensity controller 22. The de-ringing intensity determining unit 223 looks up the lookup table 222 according to the pixel complexity C1 of the first pixel group and the pixel complexity C2 of the second pixel group, so as to obtain a corresponding de-ringing intensity coefficient. For example, the lookup table 222 is a two-dimensional table, with the horizontal direction and the vertical direction respectively representing complexities C1 and C2. Accordingly, the corresponding de-ringing intensity coefficient is looked up from the lookup table 222 with reference to a pair of complexities C1 and C2. When the resolution of the horizontal direction and the vertical direction of the two-dimensional lookup table 222 is low, the de-ringing intensity determining unit 223 obtains a more accurate de-ringing intensity coefficient by performing interpolation so as to reduce a hardware requirement of the lookup table 222.

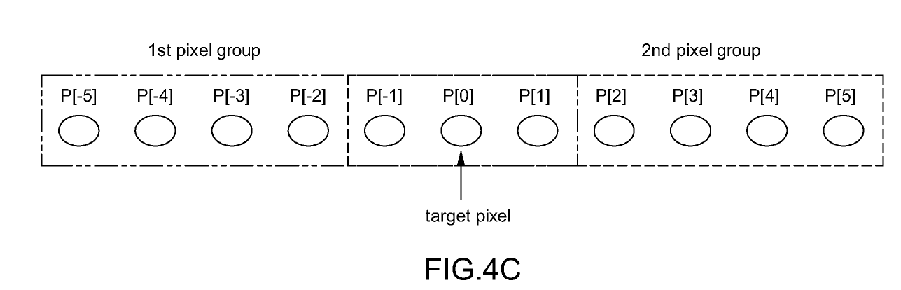

In this embodiment, the pixels represented by the first pixel group and the second pixel group are partially overlapped. Preferably, the overlapped pixels between the first pixel group and the second pixel group are programmable in a register (not shown in FIG. 3) of the de-ringing intensity controller 22. The de-ringing intensity determining unit 223 adjusts a ring width in the output video signal outputted by the blending unit 23, by adjusting the number of overlapped pixels between the first pixel group and the second pixel group. For example, when the number of overlapped pixels between the first pixel group and the second pixel group becomes greater, the ringing of the output video signal gets wider. When the number of overlapped pixels becomes smaller, the ringing of the output video signal gets narrower. FIG. 4A, FIG. 4B and FIG. 4C respectively show circumstances of the first pixel group and the second pixel group having different numbers of overlapped pixels. The first pixel group sequence comprises pixels P[−5] to P[5], and the target pixel is pixel P[0]. In FIG. 4A, the first pixel group comprises pixels P[−5] to P[−1], the second pixel group comprises pixels P[1] to P[5], and accordingly the number of overlapped pixels is zero. In FIG. 4B, the first pixel group comprises pixels P[−5] to P[0], the second pixel group comprises pixels P[0] to P[5], and accordingly the number of overlapped pixels is one and the overlapped pixel is the target pixel P[0]. In FIG. 4C, the first pixel group comprises pixels P[−5] to P[1], the second pixel group comprises pixels P[−1] to P[5], and accordingly the number of overlapped pixels is three and the overlapped pixels are three pixels P[−1], P[0] and P[1]. Therefore, when the number of overlapped pixels of the first pixel group and the second pixel group is 2n−1, the overlapped pixels are pixel P[−n], . . . , P[−1], P[0], P[1], . . . , and P[n]. When the number of overlapped pixels between the first pixel group and the second pixel group is greater, the first pixel group extends farther after the target pixel and the second pixel group extends farther before the target pixel. Therefore, the probability that the target pixel is determined as an edge of the image is reduced; the reason is that, a condition that the target pixel is determined as an edge of the image is that the two pixel groups respectively represent the flat area and the complex area.

For example, suppose that the target pixel positions at the image edge, and the pixels before and after the target pixel are respectively the flat area and the complex area. When the first pixel group and the second pixel group, respectively representing pixel subsets before and after the target pixel, do not overlap with one another, the first pixel group and the second pixel group are respectively the flat area and the complex area. When the number of overlapped pixels between the first pixel group and the second pixel group becomes greater, pixels of originally in the first pixel group of the flat area may extend to the complex area covering the target pixel originally at the image edge and the second pixel group originally in the complex area. However, the second pixel group originally in the complex area remains in the complex area, and does not change when the number of the overlapped pixels becomes greater. Consequently, the target pixel which is originally determined as being at an edge of the image shall be determined as being in the complex area due to increasing the number of overlapped pixels. The blending unit 23 then performs alpha blending having a low de-ringing intensity, and hence the ringing of the output video signal becomes wider. Preferably, the number of overlapped pixels between the first pixel group and the second pixel group is configurable.

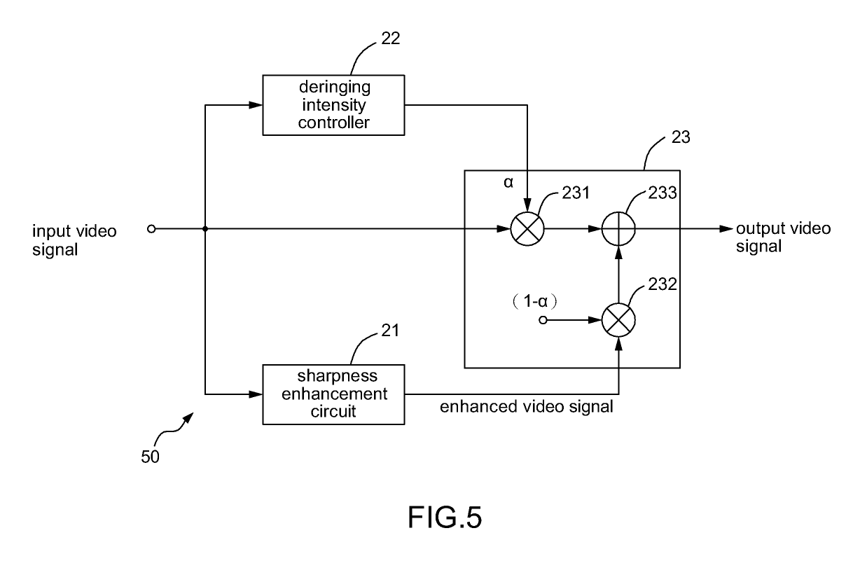

FIG. 5 is a block diagram of a de-ringing device 50 in accordance with another embodiment of the present invention. Components of the de-ringing device 50 are similar to those of the de-ringing device 20 illustrated in FIG. 2, wherein a main difference lies in connections of the components. When the blending unit 23 performs alpha blending, the input video signal is directly multiplied by the de-ringing intensity coefficient α generated by the de-ringing intensity controller 22, and the enhanced video signal outputted by the sharpness enhancement circuit 21 is multiplied by 1−α. Therefore, the de-ringing device 50 respectively adjusts the proportions of the enhancement video signal and the input video signal in the output video signal by adjusting the de-ringing intensity coefficient α, so as to achieve de-ringing.

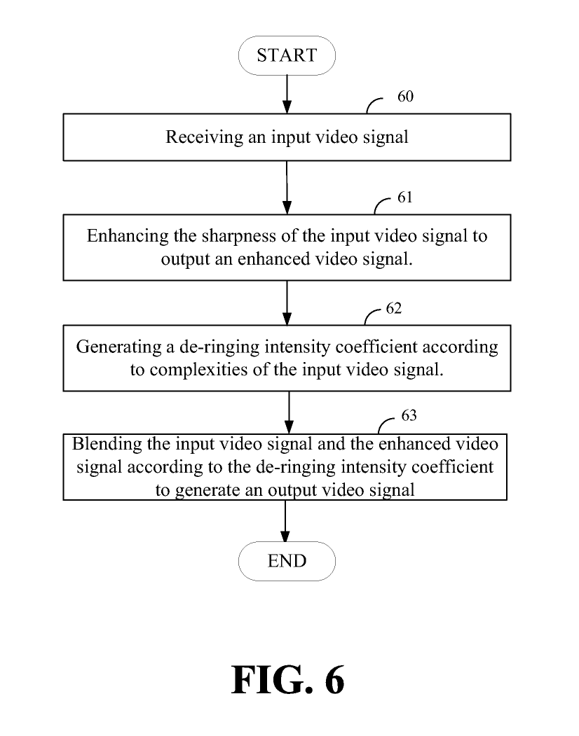

FIG. 6 is a flow chart of a de-ringing method in accordance with a preferred embodiment of the present invention. In Step 60, an input video signal is received. In Step 61, sharpness of the input video signal is enhanced to output an enhanced video signal. In Step 62, a de-ringing intensity coefficient is generated according to a complexity of the input video signal. In Step 63, blending the input video signal and the enhanced video signal according to the de-ringing intensity coefficient to generate an output video signal.

The input video signal received in Step 60 can be represented by a pixel sequence comprising a plurality of pixels, such as a horizontal line, a vertical line or a diagonal line of an image. In Step 61, differences between the pixels of the pixel sequence and adjacent pixels are enlarged to enhance the sharpness.

In Step 62, pixel complexities of a first pixel group and the second pixel group associated with a target pixel in the pixel sequence are respectively detected to determine the de-ringing intensity coefficient corresponding to the target pixel. For example, the pixel complexities of the first pixel group and the second pixel group respectively correspond to those of the pixels before and after the target pixel. The first pixel group comprises M pixels before the target pixel, and the second pixel group comprises N pixels after the target pixel, where M and N are positive integers and are determined according to an image resolution. In other words, the pixel length of the first pixel group and the pixel length of the second pixel group may vary with the image resolution of the input pixel sequence. Furthermore, in order to widen a ringing included in the output video signal in Step 63, the number of overlapped pixels between the first pixel group and the second pixel group is increased in Step 62. The ringing gets wider as the number of overlapped pixels gets greater. For example, the pixel complexity of the first pixel group is determined according a difference between a greatest pixel value and a smallest pixel value of the first pixel group. The pixel complexity of the second pixel group can be similarly determined according to a difference between a greatest pixel value and a smallest pixel value of the second pixel group.

The de-ringing intensity coefficient is further determined according to a comparison result of a pixel complexity C1 and a first threshold T1 and a comparison result of a pixel complexity C2 and a second threshold T2 in Step 62. For example, when C1 is smaller than T1 and C2 is greater than T2, the de-ringing intensity coefficient corresponds to a high de-ringing intensity. When C1 is smaller than T1 and C2 is smaller than T2, the de-ringing intensity coefficient corresponds to a low de-ringing intensity. When C1 is greater than T1 and C2 is greater than T2, the de-ringing intensity coefficient corresponds to a low de-ringing intensity. When C1 is greater than T1 and C2 is smaller than T2, the de-ringing intensity coefficient corresponds to a high de-ringing intensity. For example, the de-ringing intensity coefficient is quickly determined by looking up a lookup table, which stores de-ringing intensity coefficients corresponding to different pixel complexities of the first pixel group and the second pixel group.

In Step 63, alpha blending can be applied, but the invention is not limited thereto. Provided that the proportions of the input video signal and the enhanced video signal in the output video signal generated by the blending vary along with changes of the de-ringing intensity coefficient, various blending algorithms may be applied.

While the invention has been described in terms of what is presently considered to be the most practical and preferred embodiments, it should be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A de-ringing device, operative with a lookup table for storing a plurality of intensity coefficients, comprising:
a buffer for temporarily storing an input pixel sequence; and
a de-ringing intensity determining unit, coupled to the buffer, for respectively detecting a plurality of pixel complexities of a first pixel group and a second pixel group associated with a target pixel in the input pixel sequence, and looking up the lookup table according to the pixel complexities of the first pixel group and the second pixel group to output a de-ringing intensity coefficient.

2. The de-ringing device as claimed in claim 1, further comprising:
a sharpness enhancement circuit for enhancing sharpness of the input pixel sequence to output an enhanced pixel sequence; and
a blending unit, coupled to the sharpness enhancement circuit and the de-ringing intensity determining unit, for blending the input pixel sequence and the enhance pixel sequence according to the de-ringing intensity coefficient to generate an output video signal.

3. The de-ringing device as claimed in claim 2, wherein the blending is alpha blending.

4. The de-ringing device as claimed in claim 1, wherein the pixel complexities of the first pixel group and the second pixel group respectively associate with pixels before and after the target pixel of the input pixel sequence.

5. The de-ringing device as claimed in claim 1, wherein a number of overlapped pixels between the first pixel group and the second pixel group is configurable.

6. The de-ringing device as claimed in claim 5, further comprising a register for setting the number of the overlapped pixels between the first group and the second group.

7. The de-ringing device as claimed in claim 1, wherein the pixel complexity in each pixel group is determined according to a difference between a greatest pixel value and a smallest pixel value of the first pixel group.

8. The de-ringing device as claimed in claim 1, wherein the de-ringing intensity determining unit determines the de-ringing intensity coefficient according to a comparison result of the pixel complexity of the first pixel group and a first threshold and a comparison result of the pixel complexity of the second pixel group and a second threshold.

9. The de-ringing device as claimed in claim 8, wherein when the pixel complexity of the first pixel group is smaller than the first threshold and the pixel complexity of the second pixel group is greater than the second threshold, the de-ringing intensity coefficient represents a high de-ringing intensity.

10. The de-ringing device as claimed in claim 8, wherein when the pixel complexity of the first pixel group is smaller than the first threshold and the pixel complexity of the second pixel group is smaller than the second threshold, the de-ringing intensity coefficient represents a low de-ringing intensity.

11. The de-ringing device as claimed in claim 8, wherein when the pixel complexity of the first pixel group is greater than the first threshold and the pixel complexity of the second pixel group is greater than the second threshold, the de-ringing intensity coefficient represents a low de-ringing intensity.

12. A de-ringing method, comprising:
receiving an input pixel sequence;
detecting a plurality of pixel complexities of a first pixel group and a second pixel group associated with a target pixel in the input pixel sequence; and
determining a de-ringing intensity coefficient for the target pixel according to the pixel complexities of the first pixel group and the second pixel group.

13. The de-ringing method as claimed in claim 12, further comprising:
enhancing sharpness of the input pixel sequence to output an enhanced pixel sequence; and
performing blending on the input pixel sequence and the enhanced pixel sequence to generate an output video signal.

14. The de-ringing method as claimed in claim 12, wherein the step of determining the de-ringing intensity coefficient determines the de-ringing intensity coefficient by looking up a lookup table.

15. The de-ringing method as claimed in claim 12, wherein the pixel complexities of the first pixel group and the second pixel group are respectively corresponding to pixel complexities of pixels of the input pixel sequence before and after the target pixel.

16. The de-ringing method as claimed in claim 12, further comprising determining the number of overlapped pixels between the first pixel group and the second pixel group.

17. The de-ringing method as claimed in claim 12, wherein a pixel length of the first pixel group and a pixel length of the second pixel group are determined according to an image resolution of the input pixel sequence.

18. The de-ringing method as claimed in claim 12, wherein the pixel complexity of the first pixel group is determined according to a difference between a greatest pixel value and a smallest pixel value of the first pixel group.

19. The de-ringing method as claimed in claim 12, wherein the de-ringing intensity coefficient is determined according to a comparison result of the pixel complexity of the first pixel group and a first threshold and a comparison result of the pixel complexity of the second pixel group and a second threshold.

20. The de-ringing method as claimed in claim 19, wherein when the pixel complexity of the first pixel group is smaller than the first threshold and the pixel complexity of the second pixel group is greater than the second threshold, the de-ringing intensity coefficient represents a high de-ringing intensity.
